(19) United States
(12) Patent Application Publication
(10) Pub. No.: US 2010/0006355 A1
(43) Pub. Date: Jan. 14, 2010

(54) Vehicle having longitudinally set-apart wheel supports

(76) Inventor: W. Reynolds Smith, Greenacres, WA (US)

Correspondence Address: Gregory IPL, P.C., 601 W. Main Avenue, Suite 904, SPOKANE, WA, 99201-3825, US

(21) Appl. No.: 12/218,379

(22) Filed: Jul. 14, 2008

(51) Int. Cl. B62D 61/10

(52) U.S. Cl. 180/24

(57) ABSTRACT

One embodiment includes a vehicle defined by a first side, a second side, and a longitudinal axis between the sides. The vehicle includes a plurality of vehicle supporting wheels consisting of a first wheel proximate the first side, a second wheel proximate the second side, and a plurality of tertiary wheels. The first and second wheels are not symmetrical with one another, nor with any tertiary wheel, across the longitudinal axis.

### TECHNICAL FIELD

The technical field relates to wheeled vehicles, and is particularly useful for commercial vehicles having multiple axle configurations.

### BACKGROUND OF THE INVENTION

Many commercial vehicles such as trucks, buses, etc. are configured with a single set of front wheels, and four or more rear wheels which are supported by two or more rear axles. A common rear wheel configuration for commercial vehicles is to have two solid rear axles mounted to a frame by a suspension system, wherein each rear axle supports two wheels on each side of the truck, for a total of 8 rear wheels. The arrangement of having two wheels mounted on each side (left and right) of a solid rear axle is known as dual tires. However, a relatively recent practice is to replace the two thinner tires on each side of a rear axle with one single-wide tire. Thus, there are at least four tires mounted in a rectangular arrangement on a typical commercial vehicle having two rear axles. Similarly, there are at least four tires mounted in a rectangular arrangement on a typical commercial vehicle having a single rear axle and one or more front axles.

When a commercial vehicle is provided with two rear axles, at least one of the axles may be a driven axle. Alternatively, such as on a semi-trailer, the trailer rear wheels may be undriven. Driven axles have wheels mounted to the axle which are driven by a drive shaft, typically through a differential mounted in the typically monolithic axle assembly. Such wheels are referred to as drive wheels. When the wheels of only a single axle are driven, the configuration is known as single drive. In other configurations both of the rear axles are driven axles, in which case the configuration is known as tandem drive. Further, in situations where the vehicle is expected to carry or tow very heavy loads, three or more rear axles can be used. Oftentimes any third or subsequent rear axle is not a driven axle (i.e., the wheels supported on the axle are not driven wheels) and the axle merely serves to support the weight of the vehicle and distribute the weight over the road surface. Such an axle is known as a dead axle, and is often mounted for movable deployment depending on load.

In commercial vehicles, virtually all rear axles are solid axles—i.e., the axle forms a solid member between wheel supports on opposite sides of the axle. However, the use of solid rear axles in commercial vehicles has certain disadvantages. One particular disadvantage is that forces acting on one side of the axle are transmitted, at least in part, directly to the wheel on the other side of the axle. Another disadvantage to the use of a solid axle is that any change in tire camber resulting from vertical movement of one wheel will also be experienced by a wheel and tire on the opposite side of the axle.

Generally, solid axle suspension systems are poor at isolating forces between wheels on opposite sides of the axle, thus resulting in a lower quality of ride and relatively poor handling. However, the weight bearing capability of the solid axle design has been viewed as the best conventional design.

There are also heavy vehicles such as cranes and military vehicles which use two axles at the front of the vehicle to provide adequate support. The above description of the transmission of disadvantageous effects on steering, control and ride thus may also be experienced in vehicles with multiple axles at the front, rear or otherwise located on the vehicle.

Some or all of the problems explained above and other problems not discussed may be helped or solved by the disclosures contained herein. Such disclosures may also be used to address other problems not set out above or which develop or are appreciated at a later time. The future may also bring to light unknown or currently unappreciated benefits which may in the future be recognized or appreciated from the embodiments shown and described herein.

### BRIEF DESCRIPTION OF THE DRAWINGS

Preferred forms, configurations, embodiments and/or diagrams relating to and helping to describe preferred versions of the inventions are explained and characterized herein, often with reference to the accompanying drawings. The drawings and all features shown therein also serve as part of the disclosure of the inventions of the current application whether described in text or merely by graphical disclosure alone. Such drawings are briefly described below.

FIG. 1 is a plan view of an exemplary commercial vehicle in accordance with one embodiment described herein.

FIG. 2 is an end sectional view of the vehicle depicted in FIG. 1.

FIG. 3 is a plan view of an exemplary commercial vehicle in accordance with another embodiment described herein.

FIG. 4 is an end sectional view of the vehicle depicted in FIG. 3.

FIG. 5 is a schematic diagram of an exemplary control system in accordance with a further embodiment described herein.

FIG. 6 is a schematic diagram of an exemplary control system in accordance with yet another embodiment described herein.

### DETAILED DESCRIPTION OF THE PREFERRED EMBODIMENTS

### Table Listing Subsections of Detailed Description

A table of subsections for the detailed description is set out below.

### Table of Subsections

Table Listing Subsections of Detailed Description

Introductory Notes

First Embodiment—Vehicle having offset wheels

Second Embodiment—Vehicle resource management system

Third Embodiment—Modular multiple vehicle drive components

Fourth Embodiment—Vehicle having offset rear wheels

Fifth Embodiment—Vehicle having multiple power units

Sixth Embodiment—Vehicle control system

Seventh Embodiment—Method of controlling vehicle power

Eighth Embodiment—Method of supporting wheels on a vehicle

Interpretation Notes

### Introductory Notes

The readers of this document should understand that the embodiments described herein may rely on terminology used in any section of this document and other terms readily apparent from the drawings and the language common therefor as may be known in a particular art and such as known or indicated and provided by dictionaries. Dictionaries were used in the preparation of this document. Widely known and used in the preparation hereof are Webster's Third New International Dictionary (©1993), The Oxford English Dictionary (Second Edition, ©1989), and The New Century Dictionary (©2001-2005), all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms or features shown in one embodiment that may also apply to or be combined with other embodiments for similar structures, functions, features and aspects of the invention and provide additional embodiments thereof. The readers of this document should further understand that the embodiments described herein may rely on terminology and features used in any section or embodiment shown in this document and other terms readily apparent from the drawings and language common or proper therefor.

Wording used in the claims is also descriptive of the invention and the text of both claims and abstract are incorporated by reference into the description entirely in the form as originally filed. Terminology used with one, some or all embodiments may be used for describing and defining the technology and exclusive rights associated herewith.

### First Embodiment—Vehicle Having Offset Wheels

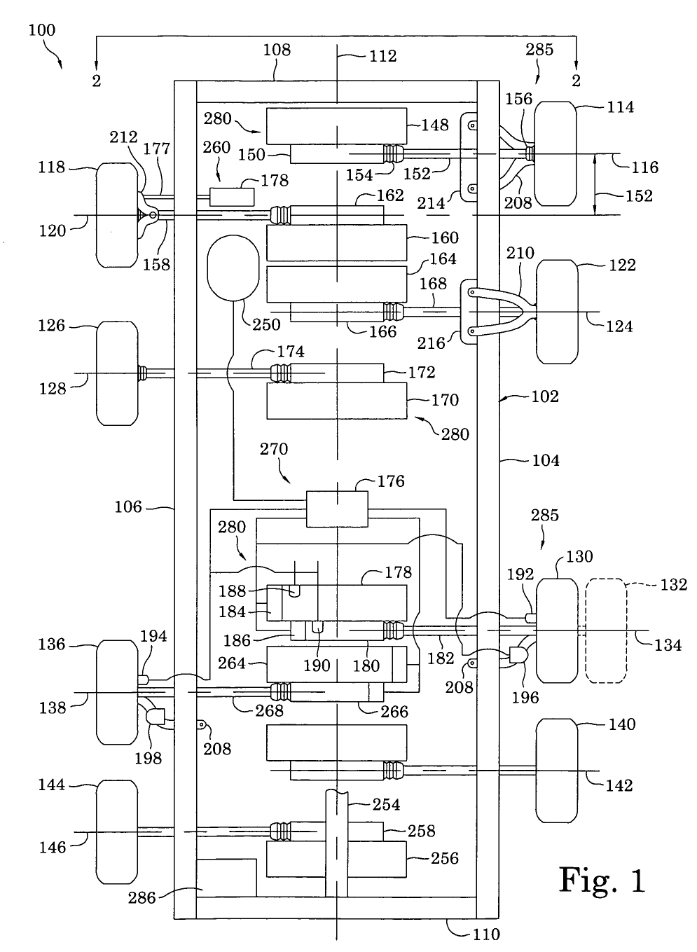

Turning now to FIG. 1, a plan view of an exemplary vehicle 100 in accordance with a first embodiment is provided. The vehicle 100 is exemplary of a commercial vehicle, and includes a chassis 102 and eight wheels, all of which are driven or powered in the example provided. For example, the vehicle 100 can be a truck tractor configured to receive a trailer via a fifth-wheel hitch (not shown). The vehicle 100 is depicted without body panels, windows, fuel tanks, and other typical components for the sake of simplifying the drawing. However, it is understood that a complete vehicle in accordance with this embodiment will typically include body panels, windows, interior fittings, accessory components, etc. The vehicle 100 of FIG. 1 is defined by a first side (located along chassis side member 104), a second side (located along chassis side member 106), a front (located proximate front cross member 108) and a rear (located proximate rear cross member 110). The vehicle 100 is further defined by a longitudinal axis 112 which is generally parallel to the side members 104 and 106. The vehicle 100 is thus depicted as a body-on-frame type vehicle. However, other chassis configurations can be used, such as a unibody or monocoque design.

The vehicle 100 includes four front wheels 114, 118, 122 and 126 located proximate the front of the vehicle 100. The front wheels 114, 118, 122 and 126 are supported on the chassis 102 by front suspension systems which will be described more fully below. While the wheels 114, 118, 122 and 126 have been described as being supported on the chassis 102, it is equally appropriate to describe the wheels of the vehicle 100 as supporting the vehicle. That is, the wheels of the vehicle 100 are connected to the chassis 102 via a suspension system which allows compliance between the wheels and the chassis. The vehicle 100 further includes four rear wheels 130, 136, 140 and 144 which are located proximate the rear of the vehicle, and which are supported by the chassis 102 via suspension systems. Wheel 132, which is paired with wheel 130, demonstrates how dual wheels can be optionally mounted at each wheel position. The wheels 114, 118, 122, 126, 130, 136, 140 and 144 support the chassis 102 at respective wheel positions 116, 120, 124, 128, 134, 138, 142 and 146. The wheel positions can alternately be described as effective axle positions. The effective axle positions coincide with the positions that are occupied along the longitudinal axis 112 by axles if the wheels are mounted to the chassis using axles. The effective axle positions also coincide with the wheel centers for wheels 114, 118, 122, 126, 130, 136, 140 and 144 in FIG. 1. Front wheels are closer to the front of the vehicle than they are to the rear of the vehicle; rear wheels are closer to the rear of the vehicle than they are to the front of the vehicle.

Since the wheels 114, 118, 122, 126, 130, 136, 140 and 144 of vehicle 100 contact a road surface or the like to move the vehicle, the wheels may be described as vehicle drive elements, and are mounted to the vehicle at drive element positions. Thus other embodiments include vehicles where the drive elements are components other than wheels. For example, the drive elements can be tracks, propellers, fluid devices such as jets, and other components which are used to cause a vehicle to move under power.

Still referring to FIG. 1, front wheel positions 116, 120, 124, 128 are spaced apart from one another along the longitudinal axis 112, with a first two of the front wheels (114, 122) being supported proximate the first side of the vehicle (proximate side member 104) and the other two of the front wheels (118, 126) being supported proximate the second side of the vehicle (proximate side member 106). Thus, in a plan view the front wheels 114, 118, 122 and 126 are laid out in the pattern of a parallelogram with no corners at right angles. Put another way, the front wheels 114, 118, 122 and 126 are mounted with respect to the chassis 102 in alternating left-to-right orientation in spaced apart positions along the longitudinal axis 112. In this way the front wheels 114, 118, 122 and 126 are laterally asymmetric with respect to one another about the longitudinal axis 112. The front wheels 114, 118, 122 and 126, and their respective wheel positions 116, 120, 124 and 128, are thus longitudinally offset with respect to one another and axis 112 by offset distances defined by the effective wheel positions themselves—e.g., offset distance 152 between effective wheel positions 116 and 120.

In essentially the same way that the front wheel positions 116, 120, 124, 128 are spaced apart with respect to one another along the longitudinal axis 112 of the vehicle 100, the rear wheel positions 134, 138, 142 and 146 are also spaced apart with respect to one another along the longitudinal axis 112 of the vehicle.

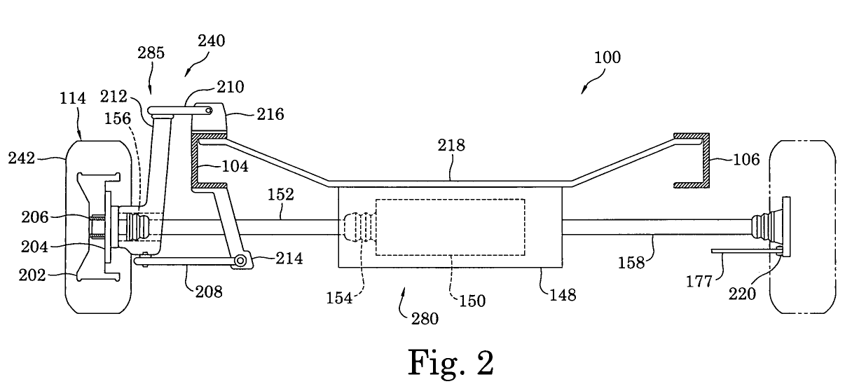

Front wheels 114, 118 and 122 are depicted in FIG. 1 with exemplary suspension components that can be used to support the wheels from the vehicle 100. FIG. 2 is a front view of the vehicle 100 of FIG. 1, and shows a suspension system 240 for the wheel 114 of FIG. 1. The exemplary suspension system 240 depicted in FIG. 2 is an independent suspension, and includes unequal length upper and lower arms or yokes 210 and 208, also known as A-arms. Upper arm 210 is pivotably joined to chassis member 104 by upper frame mounting 216, while lower arm 208 is pivotably joined to chassis member 104 by lower frame mounting 214. The arms 210 and 208 are held in spaced-apart relationship to one another by an upright 212, which is connected to the arms in a manner which allows pivotable movement of the arms with respect to the upright and, in this instance, to allow the upright to rotate with respect to the arms for steering purposes. The upright 212 further rotationally supports a wheel hub 204. Wheel 114, which includes tire 242 and rim 202, is mounted to the hub 204 via studs 206 using fasteners (not shown). Returning to FIG. 1, different components of the suspension system 240 of FIG. 2 are depicted in plan view at different wheel positions. Specifically, the lower arm 208 and lower frame mounting 214 can be seen in plan view at wheel position 116, the upper arm 210 and upper frame mounting 216 can be seen at wheel position 124, and the upright 212 can be seen at wheel position 120. Also visible at wheel position 120 is steering system 260 which includes steering arm 177 and steering actuator 178, which are used in conjunction with one another, and with a steering knuckle 220 (FIG. 2) to steer wheel 118. Steering knuckle 220 is used to connect the steering arm 177 to the wheel. Other forms of steering mechanisms can be used, such as separate steering positioners located at each steerable wheel.

The suspension system 240 of FIG. 2 can be used to mount any or all of front wheels 114, 118, 122 and 126 to the vehicle 100. Likewise, the same or a similar suspension system as 240 can be used to mount rear wheels 130, 136, 140 and 144 of FIG. 1 to the vehicle. Further, front wheels 114, 122 and 126 (and even rear wheels 130, 136, 140 and 144) can be provided with the same or similar steering system as the system 260 shown for front wheel 118. It will be appreciated that the suspension system 240 and the steering system 260 are exemplary only, and that other forms can be used. For example, the wishbone suspension system 240 can be replaced with a McPherson strut suspension, a multi-link suspension, or less preferably, a solid axle suspension.

With continued respect to FIG. 1, wheel 114 is depicted as being driven by motor 148 via transmission 150 and drive shaft 152. Drive shaft 152 is connected to the transmission 150 and wheel 114 by continuously variable joints, also commonly known as CV joints, 154 and 156. The use of CV joints to mount the drive shaft 152 allows wheel 114 to move vertically with respect to the motor 148, as can be seen in FIG. 2. As also depicted in FIG. 2, motor 148 is secured to the vehicle 100 by cross member 218 which is in turn supported by frame members 104 and 106. Other methods of supporting the motor 148 and transmission 150 from the vehicle can be used. For example, returning to FIG. 1, motor 256 (proximate the rear of the vehicle 100) and transmission 258 are supported from a central chassis member 254 (which is only partially shown).

As further depicted in FIG. 1, the remaining front wheels (118, 122, 126) are driven by respective motors 160, 164 and 170 via respective transmissions 162, 166 and 172 and drive shafts 158, 168 and 174. Likewise, rear wheels 130, 136, 140 and 144 can be provided with motors and transmissions to drive the wheels (three of which are specifically identified in FIG. 1—motors 178, 256 and 264, and transmissions 180, 258 and 266). The motors can be any kind of prime mover configured to apply power to a drive element (e.g., wheels). For example, the motor can be an internal combustion engine, a gas turbine, a fuel cell, or an electric motor. The motor can also be a combination combustion/electric hybrid energy drive system. In certain instances a transmission can beneficially be interposed between the motor and the drive element, as depicted in FIG. 1 (e.g., transmission 150 between motor 148 and drive wheel 114), while in certain applications and configurations a transmission may optionally be eliminated. Examples of transmissions include gear reducing transmissions (including continuously variable transmissions) and torque converters.

Vehicle 100 of FIGS. 1 and 2 thus provides one example of a vehicle in accordance with the current disclosure. Vehicle 100 includes eight wheels (114, 118, 122, 126, 130, 136, 140 and 144) mounted to the vehicle at respective longitudinally spaced-apart wheel positions (116, 120, 124, 128, 134, 138, 142 and 146). Each wheel (114, 118, 122, 126, 130, 136, 140 and 144) of the vehicle 100 in FIG. 1 is depicted as being provided with a dedicated motive source (motor) to drive the respective wheel. In one variation on the vehicle 100 of FIG. 1, the vehicle includes at least two drive elements (e.g., wheels) that are spaced-apart along a longitudinal axis defining the vehicle, and the spaced-apart drive elements are located proximate to at least one of the front or the rear of the vehicle. While the vehicle can include as few as three drive elements (wheels), preferably the vehicle includes four drive elements, at least two of which are spaced-apart as described. The vehicle preferably further includes at least two prime movers (e.g., motors) coupled to at least two distinct drive elements. More preferably, the drive elements driven by the at least two prime movers are the spaced-apart drive elements.

More generally, it can be seen that the first embodiment provides for a vehicle (100) having a first wheel (e.g., wheel 114) proximate the first side of the vehicle (i.e., near side member 102), and a second wheel (e.g., wheel 118) proximate the second side (i.e., near side member 106), as well as a plurality of tertiary wheels (e.g., wheels 122, 126, 130, 136, 140 and 144—i.e., all of the remaining vehicle-supporting wheels of the vehicle beyond the first and second wheels). In this embodiment, the first and second wheels are not symmetrical with one another, or with any tertiary wheel, across the longitudinal axis 112.

Still with reference to FIG. 1, the vehicle 100 can include a control system 270 (which includes at least controller/processor 176) for controlling various performance aspects of the vehicle 100. The control system 270 will be described in fuller detail below.

### Second Embodiment—Vehicle Resource Management System

With continued reference to FIG. 1, a second embodiment provides for a control system to manage consumptive systems in a vehicle. A consumptive system is any system that consumes a resource such as energy. For example, the motors 148, 160, 164, 170, 178, 264 and 256 are consumptive systems since they consume energy in driving the respective wheels of the vehicle 100. Power driven accessories (such as air conditioning and active suspension systems) are further examples of consumptive systems. Another example of a consumptive system is a cooling system for a motor, since the function of the cooling system is to dissipate heat. Each consumptive system has an optimal operating condition for the task being performed by the system. For example, a motor can be defined as performing at its optimal condition when the fuel or energy consumption of the motor is minimized for a given vehicle speed. As a specific example, in order to drive the vehicle 100 at a speed of 60 miles per hour, the wheel 130 may need to rotate at a speed of approximately 672 rpm (assuming a 30 inch outside tire diameter). Thus transmission 180 will convert the output of motor 178 into rotational output at shaft 182 of approximately 672 rpm. Using previously-determined engine performance information, and information regarding the properties of transmission 180, it might be determined that motor 178 is most energy efficient when operated at a speed of 3000 rpm in order for transmission 180 to achieve an output of 672 rpm. Therefore, in order to minimize energy consumption at motor 178 for a vehicle velocity of 60 mph, the motor/transmission consumptive system is operated at certain parameters. Where more than one motor is used to drive a vehicle (as for example, in the vehicle 100 of FIG. 1), then under certain conditions the motors can be operated at different parameters from one another in order to achieve the optimal efficiency for each motor and thus for the vehicle as a whole. In order to achieve the optimization of several consumptive systems in a single vehicle, a control system is beneficially employed.

Control system 270 of FIG. 1 includes controller 176 which can be a processor (such as a microprocessor). The processor 176 can be programmed to perform a set of computer-executable instructions for coordinating the operation of a plurality of consumptive systems in the vehicle 100 (such as motors 148, 160, 164, 170, 178, 264 and 256) to thereby efficiently operate the vehicle. The control system 270 of FIG. 1 includes a plurality of wheel condition sensors, such as wheel condition sensors 192 (at wheel 130) and 194 (at wheel 136). The wheel condition sensors 192, 194 can detect one or more conditions present at the respective wheel. For example, the wheel condition sensors can detect vertical acceleration of the wheel (indicating a road surface irregularity) and/or the rate of rotation of the wheel (allowing a determination to be made that a wheel is slipping or, alternately, that a wheel is locking under braking). While wheel condition sensors 192, 194 are only depicted as being present at wheels 130 and 136, in fact wheel condition sensors can be located at additional wheels and, preferably, at least at all of the driven wheels and more preferably, at all of the wheels. The wheel condition sensors communicate their signals to the processor 176.

The control system 270 also includes motor condition sensors 188, one of which is depicted at motor 178. The other motors 148, 160, 164, 170, 264 and 256 are also preferably provided with motor condition sensors. The motor condition sensors can detect operating conditions at each motor, such as operating speed (rpm), instantaneous fuel consumption, temperature, etc. The control system 270 can optionally include transmission condition sensors 190, one of which is depicted at transmission 180. The other transmissions 150, 162, 166, 172, 266 and 258 can also optionally be provided with transmission condition sensors. The transmission condition sensors can detect operating conditions at each transmission, such as temperature. The motor condition sensors and transmission condition sensors communicate their signals to the processor 176.

The control system 270 can also include motor controllers 184, one of which is depicted at motor 178. The other motors 148, 160, 164, 170, 264 and 256 are also preferably provided with motor controllers. The motor controllers can be controlled by the processor 176, and can enable control over various aspects of the motor, such as current (for an electric motor), fuel include transmission controllers 186, one of which is depicted at transmission 180. The other transmissions 150, 162, 166, 172, 266 and 258 are also preferably provided with transmission controllers. The transmission controllers can be controlled by the processor 176, and can enable control over various aspects of the transmission, such as gear selection, clutch coupling, etc.

As part of the control system 270, the vehicle can also include active suspension components, two of which are depicted as 196 (at wheel 130) and 198 (at wheel 136). The remaining wheels can also be provided with active suspension components. The active suspension components can be controlled by the controller 176. The vehicle 100 can also include an operator station 250, from where an operator can send control instructions (such as instructions to accelerate or brake the vehicle) to the controller 176. The steering system 260 can also be communicatively linked to the controller 176 so that the controller can use steering data (e.g., steering angle) for certain calculations. Other sensor types (not shown) can be used to provide information to the controller 176, such as vehicle yaw and roll sensors, active cruise control sensors, crash sensors (accelerometers), etc.

In operation, the control system 270 can control the consumptive systems of the vehicle in several different ways. For example, when the vehicle is moving in a generally rectilinear direction at a steady state speed, the controller 176 can determine that only some of the motors are required to maintain the vehicle speed. The controller may then instruct certain of the motors to shut down so that the remaining motors are operating at or near their most efficient parameters. In one variation, rather than shutting down motors, the controller 176 can instruct certain transmissions to temporarily disengage their respective motors. This allows the respective motor to idle, thus reducing energy consumption. The idling motors can thereafter be shut down after a predetermined period of time, thus further reducing energy consumption.

In another example, when the vehicle 100 is turning, the controller 176 can determine the turn radius (from the turn angle information from the steering system 260) and can drive the inside wheels at a slower rate than the outside wheels. This allows both the inside and outside wheels to be driven during a turn, which provides better vehicle control through a turn versus allowing one wheel to idle (as is the case with a prior art vehicle having an open differential).

The use of the control system 270 in the vehicle 100, along with the configuration of plural motors, plural transmissions, and various sensors, allows the controller 176 to operate the various systems, and thus the overall vehicle, at a preferred operating condition. Further, the use of a programmable controller allows the control system 270 to be variously configurable to optimize different parameters, depending upon user preferences, anticipated uses, anticipated operating conditions, etc. For example, the controller 176 can be configured to reduce energy consumption at the motors as a primary objective. The controller 176 can also be programmed to improve vehicle performance (e.g., acceleration, cornering and the like) at the expense of a certain amount of energy efficiency. The ability to selectively turn on and turn off individual motors at each driven wheel, to operate the motors at each driven wheel at different speeds, and/or to select different power transfer rates (using the transmission controllers) at each wheel, all in response to sensed operating conditions, provides the operator with an exceedingly high degree of control over the vehicle not previously available.

One advantage of providing separate motors for each driven wheel is that an optimal or preferred operating condition can be established for each motor. That is, what may be an optimal operating condition (speed, fuel flow, etc.) for one motor may not be an optimal operating condition for another motor at the same instant. By allowing each motor to operate at its own optimum operating condition, the overall operating efficiency of the vehicle can be increased over prior art vehicles. This is a notable improvement over prior art configurations wherein one motor drives all of the driven wheels, and an operating condition for the motor is selected based on an average condition at the driven wheels (e.g., traction), or based on the condition at only one driven wheel. This results in the power provided to some driven wheels being provided at close to optimum, whereas power provided to other wheels is not provided at or near optimum operating conditions due to differences in situational conditions (e.g., traction, braking, turning, etc.) from wheel to wheel. As just one example, while accelerating in a prior art vehicle, it is not uncommon for one wheel to spin as a result of too much power being applied to the wheel. Thus, the non-spinning wheel is being provided power at close to an optimal operating condition of the motor, whereas the spinning wheel is being provided power in excess of what is optimal for the road conditions. In this case, the motor is producing more power than necessary, thus wasting energy. By contrast, using the methods and apparatus of the current invention, each driven wheel is provided with only as much power as is needed to ensure optimal acceleration by virtue of having a dedicated power supply (motor) at each of the driven wheels, thus reducing energy consumption in the example just provided.

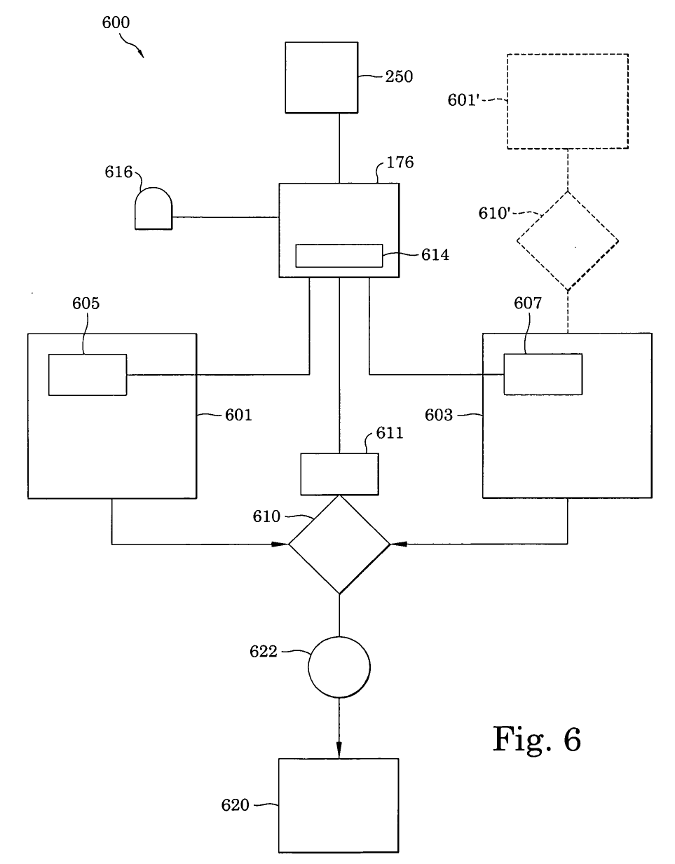

A further variation of the current embodiment is depicted in FIG. 6. FIG. 6 is a schematic diagram depicting a quantized power supply system 600. The power supply system 600 is particularly useful for selectively coupling two or more mechanical power sources to a single mechanical driver such as a wheel or a propeller or the like. The system 600 includes at least two power supplies 601 and 602. The multiple power supplies 601 and 603 can, for example, replace any one or more of the individual motors of the vehicle 100 in FIG. 1 (e.g., motor 178). The system further includes a power coupler 610. The power coupler 610 can be, for example, any one of the transmissions of the vehicle 100 in FIG. 1 (e.g., transmission 180), or it can be separate from any transmissions. The system also includes a driver 620 which can be, for example, any one of the wheels of the vehicle 100 in FIG. 1 (e.g., wheel 130). The system 600 can optionally include one or more transmissions (such as a gear reduction unit or a torque converter). For example, the system 600 can include a single transmission 622 interposed between the power coupler 610 and the driver 620, or the system can include a separate transmission (not shown) for each power supply 601, 603 interposed between the power supplies and the power coupler 610.

In operation, power is routed from power supplies 601 and/or 602 to the driver 620 via power coupler 610. Power coupler 610 can selectively connect either one, or both, of power supplies 601 and 603 to the driver 620. For example, when power supplies 601 and 603 are motors having drive shafts for power output, then power coupler 610 can be an electrically engagable clutch unit that can selectively engage and disengage the output drive shafts to a single input shaft connected to driver 620. Coupler 610 can be selectively actuated by coupler controller 611 under the control of processor 176. Likewise, each power supply 601, 603 can be provided with a power supply controller (respectively, 605, 607) which can operate similarly to the motor controller 184 of FIG. 1. That is, the power supply controllers 605, 607 can, under the control of processor 176, change the operating parameters of the respective power supplies 601, 603. For example, the power supply controllers 605, 607 can cause the respective power supplies 601, 603 to generate more power, less power, to become idle, or to power up from an inactive state. The control of the power supplies 601, 603, and the coupler 610, can be governed by a control program 614, which includes a series of computer executable instructions (stored in a computer readable memory) for determining preferred control of the system 600 in response to user inputs from user station 250 as well as signals from sensors 616. An example of sensors 616 are sensors 192 and 188, described above with respect to FIG. 1.

By being able to selectively decouple a power supply 601, 603 depending on the demand at the driver 620, energy savings can be appreciated over a prior art system having only a single power supply coupled to a driver. While only two power supplies 601, 603 are depicted in FIG. 6, it will be appreciated that the methods disclosed herein allow for more than two power supplies to be selectively coupled and decoupled to a single driver according to the power requirement at the driver.

In one variation depicted in FIG. 6, rather than configuring power supplies 601 and 603 in parallel, the power supplies can be configured in series. For example, power supply 501′ (shown in dashed line) can be serially connected to power supply 503 using power coupler 510′ (also shown in dashed line). Further, power supplies can also be coupled in parallel as well as in series (e.g., the system 600 can include all of power supplies 501, 503 and 501′, as well as a counterpart to power supply 501′ placed in-line with power supply 501. One example of a serial power supply configuration is to place two reciprocating internal combustion engines in-line (e.g., as indicated with power supplies 501′ and 503), with the power coupler (510′) being a clutch or torque converter. In this example the output from power supply 503 can be a power shaft which can be coupled directly to transmission 622 (rather than being directed to power coupler 510).

### Third Embodiment—Modular Multiple Vehicle Drive Components

With continued reference to FIGS. 1 and 2, the vehicle 100 can include a plurality of modular drive assemblies 280, three of which are specifically called-out in FIG. 1. One exemplary modular drive assembly is located proximate the front of the vehicle 100 near front chassis member 108, and includes motor 148 and power transfer unit (e.g., transmission) 150. As can be seen in FIG. 2, motor 148 and transmission 150 can be secured to the motor support member 218. Thus, any given modular drive assembly 280 can be removed from the vehicle 100 without the need to remove any of the other modular drive assemblies. For example, motor 148 can be removed for service without removing or disabling the remaining motors. Since all of the motors 148, 160, 164, 170, 178, 264 and 256 can be powered using a common power supply (e.g., a battery pack, a fuel tank or a fuel cell), each motor can be connected to the power supply using a non-permanent connector (e.g., a plug in the case of batteries, or a quick tubing fitting in the case of liquid fuel). Further, all of the electrical conductors between any modular drive assembly 280 and the controller 176, or with an operator interface 250, can be provided in a wiring harness provided with a non-permanent connector (such as a multi-pin plug). Further, wireless communication protocols can be used for some systems (e.g., sensors) to reduce the number of physical connectors to each modular drive assembly 280. In this way, any given modular drive assembly 280 needing service or replacement can be quickly isolated and removed from the vehicle 100, and a replacement unit can be quickly installed. A vehicle can thus be quickly restored to service since any modular drive assembly 280 can be serviced separate from the vehicle. Further, should a motor become non-operational during use in the vehicle, the vehicle will still be provided with one or more additional motors, and will thus not be completely disabled. The modularity provided by the system described herein also allows the number of modular drive assemblies 280 for a vehicle to be varied according to the intended use of the vehicle. For example, driven wheels can become non-driven wheels according to the intended use of the vehicle merely by removing the associated modular drive assembly 280. An additional advantage provided by this modularity is that non-skilled technicians can remove and install modular drive assemblies 280.

As further depicted in FIG. 1, the vehicle 100 can be provided with a plurality of modular wheel support assemblies 285. One such wheel support assembly 285 is depicted in front view in FIG. 2. The wheel support assembly 285 includes wheel 114, CV joints 154 and 156, and drive shaft 152. The wheel support assembly 285 can also include the suspension components 208, 212 and 210, as well as any active suspension components 196 (e.g., at wheel 130 in FIG. 1). An advantage of providing the modular wheel support assemblies 285, and particularly in conjunction with the modular drive assemblies 280, is that the effective number of axles for the vehicle 100 can be increased or decreased as the anticipated weight carrying requirements of the vehicle 100 may vary. Further, by constructing the vehicle 100 with various mounting points for the wheel support assemblies 285 on the chassis 102, a vehicle can be assembled from modular components (chassis 102, modular drive assemblies 280 and modular wheel support assemblies 285) as needed by a user. In this way, a user (such as the owner of a fleet of delivery trucks) can purchase the modular components and assemble trucks as necessary in order to satisfy the requirements for the overall fleet. Providing various mounting points for the wheel support assemblies 285 on the chassis 102 also allows standardized suspension components to be used in different countries, and the effective axle locations can be selected during setup of a vehicle in order to comply with local regulations regarding axle spacing.

Returning to FIG. 1, in an additional variation consistent with the modularity described above, the vehicle 100 can be provided with an accessory power supply 286 which is configured to provide power for accessories (such as lighting, air conditioning, etc.) as well as for the controller 176. Accessory power supply 286 can be, for example, an electrical supply such as a battery, an internal combustion engine driving a generator, a fuel cell, or a combination unit (e.g., wherein an internal combustion engine drives the generator to charge batteries). In this way the vehicle accessories, and the controller 176, will not be dependent on any given motor for power. That is, the failure of any given motor driving a wheel will not result in a loss of power to the accessories and controller.

### Fourth Embodiment—Vehicle Having Offset Rear Wheels

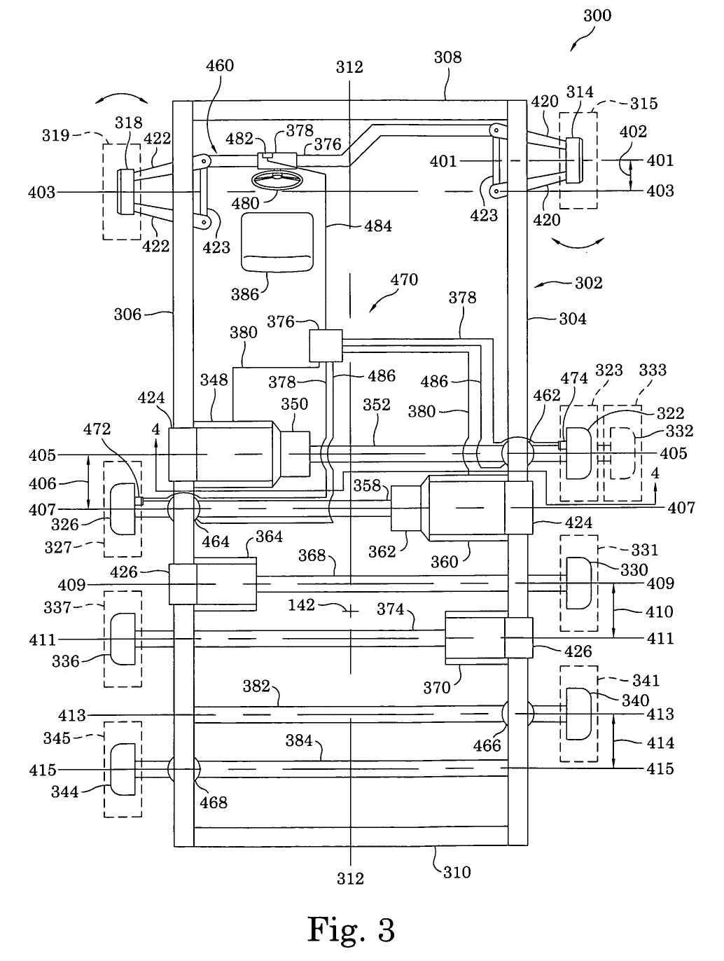

Turning now to FIG. 3, a plan view of a second exemplary vehicle 300 in accordance with the current embodiment is provided. The vehicle 300 is exemplary of a commercial vehicle having a chassis 302 and six wheels, four of which are driven or powered in the example provided. For example, the vehicle 300 can be a truck tractor configured to receive a trailer via a fifth-wheel hitch (not shown) at location 142. The vehicle 300 is depicted without body panels, windows, fuel tanks, and other typical components for the sake of simplifying the drawing. However, it is understood that a complete vehicle in accordance with this embodiment will typically include body panels, windows, interior fittings, accessory components, etc. The vehicle 300 of FIG. 3 is defined by a first side (located along chassis side member 304), a second side (located along chassis side member 306), a front (located proximate front cross member 308) and a rear (located proximate rear cross member 310). The vehicle 300 is further defined by a longitudinal axis 312 which is generally parallel to the side members 304 and 306.

The vehicle 300 includes two front wheels 314 and 318 located proximate the front of the vehicle. The front wheels 314, 318 are supported on the chassis 302 by respective front suspension members 420 and 422. It is equally appropriate to describe the wheels of the vehicle 300 as either supporting the vehicle or being supported by the vehicle. That is, the wheels of the vehicle 300 are connected to the chassis 302 via a suspension system which allows compliance between the wheels and the chassis. The vehicle 300 further includes four rear wheels 322, 328, 330 and 336 which are located proximate the rear of the vehicle. Rear wheels 322, 326, 330 and 336 support the chassis 302 via respective axles 352, 358, 374 and 382 at respective effective axle positions 405, 407, 409 and 411. Effective rear axle positions 405, 407, 409 and 411 are spaced apart from one another along the longitudinal axis 312, with a first two of the rear wheels (323, 330) being supported proximate the first side of the vehicle (proximate side member 304) and the other two of the rear wheels (326, 336) being supported proximate the second side of the vehicle (proximate side member 306). Thus, in a plan view the rear wheels 323, 326, 330, 336 are laid out in the pattern of a parallelogram having no corners that are right angles. Put another way, the rear wheels 323, 326, 330, 336 are mounted with respect to the chassis 302 in alternating left-to-right orientation in spaced apart positions along the longitudinal axis 312. In this way the real wheels 323, 326, 330, 336 are laterally asymmetric with respect to one another about the longitudinal axis 312. The rear wheels 323, 326, 330, 336, and their respective axle positions 405, 407, 409 and 411, are thus longitudinally offset with respect to one another along axis 312 by offset distances defined by the effective axle positions themselves—e.g., offset distance 406 between effective axle positions 405 and 407, and offset distance 410 between effective axle positions 409 and 411.

As depicted in FIG. 3, front wheels 314 and 318 are also supported by the vehicle 300 at respective axle positions 401 and 403 which are spaced apart from one another with respect to the longitudinal axis 312 by offset distance 402. The front wheels 314 and 318 can optionally be mounted with no offset distance along the axis 312. Front wheels 314 and 318 are shown in FIG. 3 as being connected to the chassis 302 by suspension components 420 and 422, which are depicted here as being components of a front independent suspension system. Front wheels 314 and 318 can also be connected to one another by way of a single solid axle (not shown), in which case the front wheels will not be spaced apart along the axis 312, but will be located at essentially the same position along the axis 312.

Wheels 314, 318, 323, 326, 330 and 336 of the vehicle 300 are intended to be mounted with respective tires 315, 319, 323, 327, 331 and 337, which act as an interface between the vehicle 300 and a road surface (not shown). While in FIG. 3 each axle 358, 368 and 374 is depicted as supporting only a single wheel and tire, each axle can also be configured to support a second wheel and tire in juxtaposed position to the primary wheel and tire. For example, as depicted in FIG. 3, axle 352 can support wheels 322 and 332, both of which are supported on the same side of the vehicle 300. Wheel 332 can then be mounted with tire 333. A similar arrangement can be provided at the other axles (358, 368 and 374), thus increasing the load carrying capacity of the vehicle 300.

Thus, FIG. 3 depicts a vehicle 300 having a set of front wheels (314, 318), and two sets of offset rear wheels (first set 323, 326, and second set 330, 336). In this embodiment, the vehicle 300 includes at least one set of wheels (or wheel supports) located at effective axle positions which are offset with respect to one another along the longitudinal axis 312. While FIG. 3 depicts the vehicle 300 as having an equal number of wheels supports on each side (304, 306) of the vehicle, this is not a requirement. In one variation of this embodiment (not specifically depicted in FIG. 3), the vehicle 300 has an unequal number of wheels on the two sides of the vehicle.

Further, while not specifically depicted in FIG. 3, the vehicle 300 can optionally include one or more sets of wheels (front or rear) that are laterally symmetrical about the longitudinal axis 312 (i.e., are not offset with respect to one another along the longitudinal axis 312). For example, if the offset distance 402 of FIG. 3 is zero, then front wheels 314 and 318 will be laterally symmetrical about axis 312.

The apparatus of this embodiment thus can include a vehicle having at least two diametrically opposed wheels, and at least two additional wheels that are neither diametrically opposed to one another nor to any wheel that is diametrically opposed to another wheel.

In one variation depicted in FIG. 3, the vehicle 300 can further include fifth and sixth rear wheels 340 and 344 supported on opposite sides of the chassis 312 at respective effective axle positions 413 and 415 which are spaced apart along the longitudinal axis 312 by offset distance 414. Wheels 340 and 344 are configured to be mounted with respective tires 341 and 345. Wheels 340 and 344 are depicted as being non-driven wheels, mounted on respective axles 382 and 384. As such, axles 382 and 384 are dead axles. Further, since axles 382 and 384 are located behind a drive axle (374), they are more specifically commonly known as tag axles. Dead axles can also be provided in front of drive axle 352 (in which case it is commonly known as a pusher axle), as well as between drive axles (e.g., axles 352 and 358). In general, adding more axles (driven or dead) allows the vehicle 300 to carry greater loads. A further advantage of additional axles will be discussed below.

The third embodiment can thus be implemented as a truck tractor having a set of front wheels (314, 318) and four rear wheels (323, 326, 330 and 336). At least two of the rear wheels are driven wheels. The rear wheels are supported on the vehicle at effective axle positions (405, 407, 409, 411) along the longitudinal axis 312, with two rear wheels on each side of the vehicle; all four of the effective axle positions are spaced apart along the longitudinal axis 312. In this particular example any given rear axle or effective axle position of the commercial vehicle 300 support wheels on one side or the other of the vehicle, but not on both sides. Further, the rear wheels can be supported at alternating left and right positions moving along the longitudinal axis 312 of the vehicle 300. This arrangement isolates each axle position (and thus the associated wheel or wheels), overcoming prior art problems associated with using a solid axle connecting wheels on opposite sides of the vehicle. In general, the arrangement provides the benefits associated with an independent rear suspension, while maintaining the strength and weight bearing characteristics of a solid axle design.

### Fifth Embodiment—Vehicle Having Multiple Power Units

Referring still to FIG. 3, it can be seen that the front wheels 314, 318 of the vehicle 300 are depicted as being non-driven wheels. Further, the rear wheels 323, 326, 330 and 336 are depicted as being driven wheels. More specifically, wheel 323 is depicted as being driven by internal combustion engine 348 via transmission 350, and wheel 326 is depicted as being driven by internal combustion engine 360 via transmission 362. Likewise, wheel 330 is depicted as being driven by electric motor 364, and wheel 336 is depicted as being driven by electric motor 370. Optionally, all of motors 348, 360, 364 and 370 can be electric motors, or they can all be internal combustion motors. In the variation depicted in FIG. 3, motors 348, 360, 364 and 370 can be operated in a hybrid mode. For example, electric motors 364 and 370 can be used for low speed maneuvering, and internal combustion engines 348 and 360 can be used at higher speeds. Likewise, any or all of the driven wheels 323, 326, 330 and 336 can be driven by individual internal combustion/electric hybrid systems. In one variation, a common motor can be used to drive two or more of the rear wheels. For example, a single internal combustion engine can be used to drive wheels 330 and 336, and the offset distance 410 between the wheels can be accommodated by using a common differential and half-shafts connected thereto by universal joints (or constant velocity (“CV”) joints). While FIG. 3 depicts all four rear wheels 323, 326, 330 and 336 as being driven wheels, in one variation only wheels 323 and 326 (or, alternately, 330 and 336) are driven wheels.

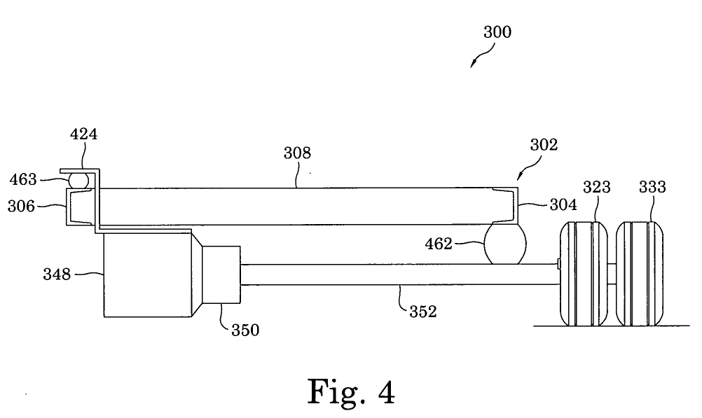

In FIG. 3 the motors 348, 360, 364 and 370 are all depicted as being located on the opposite side of the longitudinal axis 312 as their respective driven wheels. Motors 348 and 360 are depicted as being supported from respective chassis side members 304 and 306 by motor mounts 424. Likewise, motors 364 and 370 are depicted as being supported from respective chassis side members 304 and 306 by motor mounts 426. In this way, each drive wheel 323, 326, 330 and 336 can be supported by the chassis 302 at two distal locations (i.e., on each of frame rails 304 and 306), thus providing additional resistance to bending moments when under load. Motor mounts 424 and 426 can include suspension components (such as leaf springs, air suspension components, etc.) to thereby provide axles 352, 358, 368 and 374, and their associated wheels, with greater suspension compliance. The motor mounts 424 and 426 can be supported on the upper sides of frame rails 304 and 306 (as depicted in FIG. 4 for motor mount 424) in order to provide torsional resistance to bending moments imparted to the axles. FIG. 4 is an end sectional view of the vehicle 300 of FIG. 3. In FIG. 4, the axle 352 is supported by the chassis 302 at suspension component 462 at the right frame rail 304, and by motor mount 424 and suspension component 463 at the left frame rail 306.

Thus, according to the fourth embodiment, the vehicle 300 of FIG. 3 includes at least a first and a second driven wheel (e.g., wheels 322 and 326) which are offset with respect to one another along the longitudinal axis 312 of the vehicle, each of which are each driven by independent motive sources (e.g., motors 348 and 360). For convenience, driven wheels that are supported by offset wheel supports will be known herein as offset driven wheels.

In the fifth embodiment, the vehicle 300 (FIG. 3) can include a sensor system configured to sense one or more conditions at the offset driven wheels. In this case the vehicle can further include a controller or processor 376 configured to independently regulate one or more properties of the motors driving the driven wheels, and in response to input from the sensor system. For example, as depicted in FIG. 3, offset driven wheel 322 is provided with sensor system 474, while offset driven wheel 326 is provided with sensor system 472. The vehicle 300 further includes controller 376. Sensor systems 472 and 474 transmit output signals to the controller 376 using sensor signal communication lines 378, which can be electrical conductors, fiber optics, hydraulic lines, etc. Sensor signal communication lines 378 can also be implemented using a wireless transmitting and receiving device. In response to receiving the output signals from the sensor systems 472 and 474, the controller 376 processes the output signals to determine if a condition exists at the driven wheel which requires control, and when control is required, the controller 376 generates and transmits appropriate control signals via output signal lines 380. Output signal lines 380 can be electrical conductors, fiber optics, hydraulic lines, etc., and can also be a wireless transmitting and receiving device. As depicted in FIG. 3, output signal lines 380 are in signal communication with motors 348 and 360, and are thus used to control some aspect of power supplied to the respective offset driven wheels (322, 326). Sensor systems 472 and 474 can each include only a single sensor, or they can include a plurality of sensors, including sensors of different types and/or multiple ones of the same kind of sensor.

For example, sensors 472 and 474 can be configured to detect the rotational speed of respective offset driven wheels 322 and 326. Processor/controller 376 can then compare the differential rotational speed of wheels 322 and 326 and determine if one wheel is spinning unexpectedly faster than the other. Such a condition typically suggests that one wheel is losing (or has lost) traction as compared to the slower spinning wheel. Additional data which can be used by the controller 376 in order to make a determination that a wheel slippage condition is present can include steering angle (since wheels of a turning vehicle will necessarily have different rotational speeds as a function of the distance from the turn radius center) and yaw rate of the vehicle (which can be measured by a yaw rate sensor). If a wheel slip condition is detected, the controller 376 can generate a control signal (or signals) to attempt to correct the condition. For example, if wheel 326 is determined to be losing traction relative to wheel 322, then the output signal from controller 376 can direct the transmission 362 to shift up by at least one gear, thus reducing the rotational speed of the wheel. Alternatively (or additionally), the output signal from controller 376 can direct the motor 360 to reduce speed (e.g., by reducing the throttle setting). In another example, sensor systems 472 and 474 can be torque sensors, or a plurality of sensors (e.g., wheel spin sensors and torque sensors).

As depicted in FIG. 3, the vehicle 300 can include an operator position (indicated by seat 386) which provides access to a steering mechanism 460, here represented by a steering wheel 480 and a steering box 378, for converting inputs from the steering wheel into translational output energy for moving steering rack 376. Steering rack 376 is connected to front wheel supports 420 and 422, and linkages 423 connect the control arms of the wheel supports to a steering knuckle (not shown) in the wheel supports. Other arrangements of steering mechanisms can be used. The steering mechanism 460 includes a steering angle sensor 482 which can sense the steering angle input by the operator via the steering wheel 480, and can communicate the steering angle to the controller 376 by communication line 484. As indicated above, steering angle data can be used by the controller 376 to assist in making determinations as to the existence of a condition which can be controlled at one or more of motors 348, 360, 364 and 370.

In yet another variation, the vehicle 300 of FIG. 3 can be provided with an active suspension system which can be controlled by controller 376. For example, wheel support 352 can be provided with active suspension component 462 which is located between the chassis 302 and the wheel support. Similarly, wheel support 358 can be provided with active suspension component 464 which is located between the chassis 302 and the wheel support. Sensor systems 472 and 474 can include a sensor to detect a road condition, and the controller 376 can use the information about the detected road condition to control the active suspension components 462, 464 in response thereto. For example, sensor systems 472 and 474 can include accelerometers to detect rapid movement (upward or downward) of the wheel supports 322 and 326. In this case, if sensor 472 detects rapid downward movement while sensor 474 does not, the data suggests the presence of a pothole or the like in the road. The controller 376 can thus control the active suspension component 464 (via signal line 486, or a wireless equivalent) to hold the wheel support 358 in order to prevent tire 327 from crashing into the pothole. In this case the triangulated relationship of the remaining rear wheels 322, 330 and 336 provide a stable platform to support the chassis 302 of the vehicle 300. Further, in order to maintain the weight classification rating of the vehicle 300, axles 382 and 384 can be added to the vehicle to provide supplemental weight-bearing axles in the event one of the other wheels is held away from a road defect. In yet another variation, axles 382 and 384 can be provided with active suspensions 466 and 468, and axles 368 and 374 can also be provided with active suspensions (not shown). That is, all of the wheels of the vehicle 300 can be provided with active suspensions. This will allow the controller 376 to sequentially step wheels over a road imperfection (e.g., sequentially stepping wheels 322, 330 and 340 over a pothole), while at all times still providing a tripod support arrangement of rear wheels to support the vehicle.

### Sixth Embodiment—Vehicle Control System

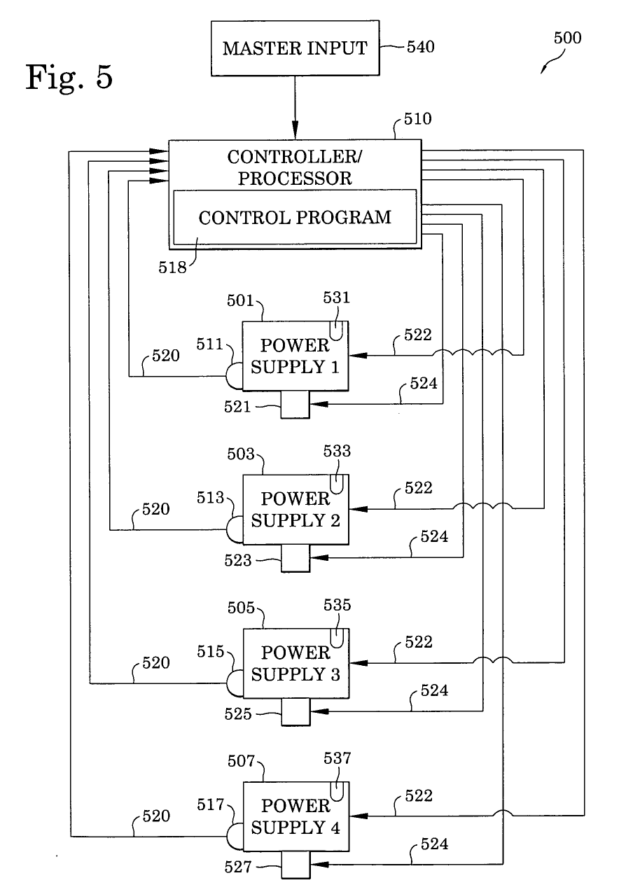

Turning now to FIG. 5, a sixth embodiment provides for a control system 500 to optimize performance of a plurality of essentially identical power supplies or consumptive systems (501, 503, 505, 507) operating in conjunction with one another. Examples of the power supplies 501, 503, 505, 507 can be the motors 348, 360, 364 and 370 of the vehicle 300 of FIG. 3. The control system 500 of FIG. 5 further includes a plurality of condition sensors 511, 513, 515, 517 dedicated to respective ones of the power supplies 501, 503, 505, 507. Each condition sensor (511, 513, 515, 517) is configured to detect a condition at a respective power supply (501, 503, 505, 507) that affects a power demand. In response to detecting a condition, a condition sensor (511, 513, 515, 517) generates an output signal. The control system 500 also includes a controller 510 configured to receive the output signals from the sensors 511, 513, 515, 517, such as by way of conductors 520. Conductors 520 can be, for example, wire, optical fiber, or implemented using a wireless communication device. The controller 510 can also be described as a processor, and can be a microprocessor or a programmable logic controller, for example. As such, the controller 510 can include a control program 518, which includes a set of computer executable instructions maintained on a computer readable medium (such as RAM or ROM memory, a hard drive, etc.). The control program 518 is configured to cause the controller to process input signals (from various sensors and user input devices, for example) and, in response, to provide control output signals for controlling various systems. More particularly, with respect to the example depicted in FIG. 5, in response to receiving the input signals from the sensors 511, 513, 515, 517, the controller 510 generates control signals (output signals) which are transmitted to the power supplies 501, 503, 505, 507 via conductors 522. The control signals are calculated to individually control the power supplies 501, 503, 505, 507 to generate power required to satisfy the respective condition as sensed by the condition sensors 511, 513, 515, 517.

By way of example, as indicated above, the power supplies 501, 503, 505, 507 of FIG. 5 can be the motors 348, 360, 364 and 370 of FIG. 3. In this example, the condition sensors 511, 513, 515, 517 can include the sensor systems 472 and 474 of FIG. 3. An exemplary type of condition sensor is the wheel slip detector discussed above with respect to FIG. 3. Based on the individual sensed condition at each power supply (501, 503, 505, 507), the controller 510 (component 376 of FIG. 3), based on a control algorithm in the control program 518, calculates control values for each power supply; the control values are converted to control signals, which are then transmitted from the controller 510 to the individual power supplies 501, 503, 505 and 507. For example, if wheel slip is detected at power supply 503 (i.e., at wheel motor 326) but not at any of the other power supplies (501, 505, 507), then the controller 510 will send a control signal to power supply 503 (i.e., motor 360) to reduce power output. This cycle will continue until wheel slip is no longer detected at power supply 503 (wheel 326), at which time the controller 510 will direct the power supply 503 to maintain the power output unless directed by an overriding input, such as operator input, or a changed condition, to change the power output.

In one variation on the control system 500 of FIG. 5, each power supply (501, 503, 505, 507) can be provided with a subsystem (521, 523, 525, 527, respectively). In this case, each of the power supplies (501, 503, 505, 507) under the control of the control system 500 includes a power supply sensor (531, 533, 535, 537, respectively). The power supply sensors (531, 533, 535, 537) are configured to detect a power supply operating condition at the respective power supply (501, 503, 505, 507) and generate a secondary signal (i.e., secondary to the condition signal generated by condition sensors 511, 513, 515, 517). The secondary signals are transmitted to the controller 510 by conductor, optical fiber, wireless transmission, etc. (not shown in FIG. 5). In response to receiving the secondary signals, the controller 510 (by way of control program 518) can be configured to generate subsystem control signals, and each subsystem control signal is transmitted to a respective one of the subsystems (521, 523, 525, 527) by way of conductors 524 or other means (optical fiber, wireless transmission, etc.).

As an example, the subsystems (521, 523, 525, 527) of FIG. 5 can be cooling units for motors, such as motors 348, 360, 364 and 370 of FIG. 3. In this example, power supply sensors (531, 533, 535, 537) can be temperature sensors, and the secondary signals are thus indicative of temperature of the respective power supply (501, 503, 505, 507). Then, the subsystem control signals transmitted from the controller 510 to the subsystems (521, 523, 525, 527) are instructions to increase, decrease, or maintain the current rate of cooling for the respective power supply (501, 503, 505, 507). An advantage of centralizing control of subsystems in a central controller versus localizing the subsystem control at the respective power supply is that a common control routine can be used for like subsystems. Thus, if an improvement is made to the control routine (control program 518), it will be available to all subsystems, rather than having to be provided to each subsystem individually. A further advantage is reduction of components, since a common controller (510) can handle the subsystem controls for all subsystems, versus having to provide a separate controller for each subsystem or at each power supply.

In yet another variation, the system 500 of FIG. 5 can include a master input device (540) which can send to the controller 510 a bulk condition to be achieved by the collective power supplies (501, 503, 505, 507). In this case the controller 510 is configured to modify the control signals (sent to the power supplies 501, 503, 505, 507) in order to achieve the bulk condition. For example, the master input device 540 can be a throttle or accelerator for a vehicle (such as vehicle 300 of FIG. 3). Thus, if the master input device 340 is used by an operator to increase the speed of the vehicle 300, the controller 510 (376, FIG. 3) will generate control signals to be sent to the driven wheels of the vehicle (e.g., power supplies 501, 503, 505 and 507 of FIG. 5) to increase speed to the selected setting.

### Seventh Embodiment—Method of Controlling Vehicle Power

A seventh embodiment provided by the present disclosure, and consistent with the control system 500 of FIG. 5, includes a method of controlling a plurality of power driven wheels in a vehicle (e.g., power driven wheels 322, 326, 330 and 336 of vehicle 300 in FIG. 3). In this method, each controlled power driven wheel has a dedicated power supply (e.g., motors 348, 360, 364 and 370, FIG. 3). The method includes the steps of detecting a status of a condition at each wheel (as, for example, by using the condition sensors 511, 513, 515 and 517, FIG. 5) and, based on the detected status of the condition at each wheel, determining a power requirement for each power supply. This step of determining the power supply requirements can be performed by the controller 510 (FIG. 5) using the control program 518. Thereafter, the method includes controlling each power supply to the respective power requirement. This last recited step can be accomplished by transmitting control signals generated by the controller 510 to the power supplies 510, 503, 505, 507 (analogous to motors 348, 360, 364 and 370 of FIG. 3).

In this method, the power requirement for each power supply can be selected (i.e., calculated) to optimize an operating efficiency of the respective power supply. For example, the power requirements can be selected to minimize energy consumption by the power supplies for a given (or selected) operating condition. As one specific example, where a power supply (such as motor 348, FIG. 3) includes a gear-reduction transmission (350), then the power requirement can include a gear selection to operate the motor at a speed (rpm) to minimize fuel consumption, yet still provide sufficient power and torque at the wheel (322) to drive the vehicle 300 at the desired velocity. Further, the method can include balancing the power requirements for all of the power supplies to achieve an overall optimum operating condition. It will be appreciated that inherent system variation can make it difficult to achieve actual minimum energy usage for any given power supply, and that the objective of optimizing an operating condition is thus understood to be within the limits provided by commercially available control system components and/or design and manufacturing costs for control system components.

The method can further include taking into account subsystems of the power supplies when determining (calculating) the power requirements. For example, if the power supply (e.g., motor) includes a cooling system as an active (versus passive) subsystem, then the method can include the step of determining an operating parameter for the cooling system to optimize an operating efficiency of the respective motor.

### Eighth Embodiment—Method of Supporting Wheels on a Vehicle

Yet another method provided for herein includes the steps of supporting wheels from a vehicle chassis such that no two wheels are diametrically opposed on opposite sides of the chassis. This arrangement is depicted in FIG. 1. In a variation on this method, a set of non-driven wheels (e.g., front wheels 314 and 318 of FIG. 3 if offset distance 402 is zero) are supported from the chassis in diametrically opposed relationship, and driven wheels (e.g., rear wheels 322 and 326, and rear wheels 330 and 336) are supported from the chassis such that no driven wheels are diametrically opposed on opposite sides of the chassis.

### Interpretation Notes

The above description has set out various features, functions, methods and other aspects of the inventions. This has been done with regard to the currently preferred embodiments thereof. Time and further development may change the manner in which the various aspects are implemented. Such aspects may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein. Also included are equivalents of the inventions which can be made without departing from the scope of concepts properly protected hereby.

I claim:

1. A vehicle defined by a first side, a second side, and a longitudinal axis therebetween, the vehicle comprising:
a plurality of vehicle supporting wheels consisting of:
a first wheel proximate the first side;
a second wheel proximate the second side; and
a plurality of tertiary wheels; and
wherein the first and second wheels are not symmetrical with one another, nor with any tertiary wheel, across the longitudinal axis.

2. The vehicle of claim 1 and wherein the first and second wheels are driven wheels.

3. The vehicle of claim 1 and further comprising a first motor configured to drive the first wheel, and a second motor configured to drive the second wheel.

4. The vehicle of claim 1 and wherein the tertiary wheels include a third wheel and a fourth wheel, and wherein the third and fourth wheels are not symmetrical with one another, nor with any of the other tertiary wheels, across the longitudinal axis.

5. The vehicle of claim 1 and wherein the tertiary wheels include a third wheel and a fourth wheel, and wherein the third and fourth wheels are symmetrical with one another across the longitudinal axis.

6. A commercial vehicle defined by a front, a rear, a first side and a second side, and a longitudinal axis connecting the front and the rear, comprising:
a first front wheel supported on the vehicle proximate the first side and at a first effective axle position;
a second front wheel supported on the vehicle proximate the second side and at a second effective axle position;
a first rear wheel supported on the vehicle proximate the first side and at a third effective axle position;
a second rear wheel supported on the vehicle proximate the second side and at a fourth effective axle position; and
wherein the effective axle positions are set apart from one another along the longitudinal axis.

7. The commercial vehicle of claim 6 further comprising:
a third rear wheel supported on the vehicle proximate the first side and at a fifth effective axle position;
a fourth rear wheel supported on the vehicle proximate the second side and at a sixth effective axle position; and
wherein the fifth and sixth effective axle positions are set apart from one another and from the other effective axle positions along the longitudinal axis.

8. The commercial vehicle of claim 7 further comprising:
a third front wheel supported on the vehicle proximate the first side and at a seventy effective axle position;
a fourth front wheel supported on the vehicle proximate the second side and at an eighth effective axle position; and
wherein the seventh and eighth effective axle positions are set apart from one another and from the other effective axle positions along the longitudinal axis.

9. The commercial vehicle of claim 6 further comprising a first motor configured to drive the first rear wheel alone, and a second motor configured to drive the second rear wheel alone.

10. The commercial vehicle of claim 9 further comprising a third motor configured to drive the first front wheel alone, and a fourth motor configured to drive the second front wheel alone.

11. The commercial vehicle of claim 6 further comprising four independent suspensions, and wherein the wheels are supported on the vehicle by the independent suspensions.

12. A commercial vehicle defined by a front, a rear, a first side and a second side, and a longitudinal axis connecting the front and the rear, comprising:
a pair of front wheels supported on the vehicle proximate the front of the vehicle; and
four rear wheels supported on the vehicle proximate the rear of the vehicle, and wherein the rear wheels are supported on the vehicle at effective axle positions which are spaced apart from one another along the longitudinal axis, a first two of the rear wheels being supported proximate the first side of the vehicle, and the other two of the rear wheels being supported proximate the second side of the vehicle.

13. The vehicle of claim 12 wherein, in a plan view, the rear wheels are arranged in the shape of a parallelogram having corners other than right angles.

14. The vehicle of claim 12 and further comprising a first motor configured to drive a first one of the rear wheels at the first side of the vehicle, and a second motor configured to drive a second one of the rear wheels at the second side of the vehicle.

15. The vehicle of claim 14 wherein the first motor is mounted to the vehicle proximate the second side of the vehicle, and the second motor is mounted to the vehicle proximate the first side of the vehicle.

16. The vehicle of claim 14 further comprising an accessory power supply configured to provide power to drive accessory components supported by the vehicle.

17. The vehicle of claim 12 and further comprising four motors, each motor driving an associated one of the rear wheels.

18. The vehicle of claim 12 and further comprising a first motor configured to drive a first one of the rear wheels, a second motor configured to drive a second one of the rear wheels, a sensor system configured to sense one or more conditions at the first and second ones of the rear wheels, and a controller configured to independently regulate one or more properties of the first and second motors in response to input from the sensor system.

19. The vehicle of claim 18 and wherein the conditions comprise wheel slip.

20. The vehicle of claim 18 and wherein the properties comprise one or more of speed, power and torque.

21. The vehicle of claim 18 and further comprising a steering mechanism to steer the front wheels, and wherein the sensor system is configured to sense a steering angle imparted to the front wheels by the steering mechanism.

22. The vehicle of claim 12 further comprising a chassis comprising a first frame rail proximate the first side of the vehicle, a second frame rail proximate the second side of the vehicle, and wherein each rear wheel is supported by the chassis from an associated dedicated suspension, each associated dedicated suspension being supported by both of the frame rails.

23. The vehicle of claim 22 further comprising four rear axles, each rear axle supporting an associated rear wheel at least in part on the associated dedicated suspensions.

24. The vehicle of claim 12 further comprising a plurality of active suspensions, each active suspension at least partially supporting a dedicated one of the rear wheels; and
an active suspension controller configured to detect at least one road condition and to selectively prevent the active suspensions from reacting to the road condition.

25. The vehicle of claim 24 and wherein the road condition is a localized depression.

26. The vehicle of claim 12 wherein the front wheels are supported on the vehicle at effective axle positions which are spaced apart from one another along the longitudinal axis.

27. The vehicle of claim 12 further comprising fifth and sixth rear wheels supported on the vehicle at effective axle positions which are spaced apart from one another and from the other rear wheels along the longitudinal axis, the fifth rear wheel being supported proximate the first side of the vehicle, and the sixth rear wheel being supported proximate the second side of the vehicle.

28. The vehicle of claim 27 and further comprising an active suspension system configured to hold one rear wheel at a time on each side of the vehicle in an position out of contact with a road surface irregularity.

29. A method of controlling a plurality of power driven wheels in a vehicle, each controlled power driven wheel having a dedicated power supply, comprising:
detecting a status of a condition at each driven wheel;
based on the detected status of the condition at each driven wheel, determining a power requirement for each power supply; and
controlling each power supply to the respective power requirement.

30. The method of claim 29 and wherein each power requirement is selected to optimize an operating efficiency of the respective power supply.

31. The method of claim 29 and wherein each power supply comprises a motor, a transmission and a cooling system, and each power requirement is selected to optimize an operating efficiency of the respective motor, transmission and cooling system.

32. A control system to optimize performance of a plurality of essentially identical power supplies operating in conjunction with one another, comprising:
a plurality of sensors configured to detect a condition affecting a power demand and generate an output in response thereto, each sensor dedicated to a respective one of the power supplies; and
a controller configured to receive the outputs from the sensors and generate a plurality of control signals in response thereto, each control signal being transmitted to a respective one of the power supplies, and wherein each control signal is calculated to control the respective power supply to generate power required to satisfy the respective condition.

33. The system of claim 32 and wherein each power supply is provided with a subsystem, the control system further comprising a plurality of power supply sensors, each power supply sensor dedicated to a respective one of the power supplies and configured to detect a power supply operating condition at the respective power supply and generate a secondary signal in response thereto, and wherein the controller is further configured to receive the secondary signals and in response to generate a plurality of subsystem control signals, each subsystem control signal being transmitted to a respective one of the subsystems.

34. The system of claim 32 and further comprising a master input device configured to send to the controller a bulk condition to be achieved by the collective power supplies, and wherein the controller is further configured to modify the control signals to achieve the bulk condition.

35. A mechanical power delivery system, comprising:
a first power supply and a second power supply, the power supplies configured to provide power in the form of mechanical output;
a driver; and
a power coupler configured to selectively transmit the power from either one or both of the power supplies to the driver in the form of mechanical energy.

36. The mechanical power delivery system of claim 35 and further comprising a controller configured to selectively couple and decouple the power supplies to the driver via the power coupler in response to a control signal provided to the processor.

37. The mechanical power delivery system of claim 36 and wherein the controller further comprises a processor, a computer readable memory, and a control program in the computer readable memory, the control program comprising a series of computer readable instructions configured to cause the controller to perform the selective coupling to minimize energy consumption by the combined power supplies.
